(19) United States
(12) Patent Application Publication
(10) Pub. No.: US 2017/0127446 A1
(43) Pub. Date: May 4, 2017

(54) STATION (STA) AND METHOD FOR NEIGHBORHOOD AWARENESS NETWORK (NAN) COMMUNICATION USING PAGING TIME BLOCKS

(71) Applicants: Po-Kai Huang, West Lafayette, IN (US); Emily H. Qi, Portland, OR (US); Elad Oren, Tel Aviv (IL)

(72) Inventors: Po-Kai Huang, West Lafayette, IN (US); Emily H. Qi, Portland, OR (US); Elad Oren, Tel Aviv (IL)

(21) Appl. No.: 15/079,878

(22) Filed: Mar. 24, 2016

Related U.S. Application Data
(60) Provisional application No. 62/249,566, filed on Nov. 2, 2015.

(51) Int. Cl. H04W 74/08; H04W 68/02

(52) U.S. Cl. CPC H04W 74/0816; H04W 68/02

(57) ABSTRACT

Embodiments of a station (STA) and method for contention based communication are generally described herein. An originating STA may transmit, during a paging window of a paging Neighborhood Area Network Data Link (P-NDL) time block, a paging message that indicates an intention of the originating STA to transmit a data frame to a destination STA. The originating STA may receive, during a transmission window of the P-NDL time block, a trigger frame (TF) from the destination STA that indicates a request to receive the data frame from the originating STA. The originating STA may determine a contention window (CW) size to be used for transmission of the data frame to the destination STA. The CW size may be determined based on other TFs exchanged between other STAs during the transmission window.

### PRIORITY CLAIM

This application claims priority under 35 USC 119(e) to U.S. Provisional Patent Application Ser. No. 62/249,566, filed Nov. 2, 2015 [reference number P92505Z (4884.397PRV)] which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards. Some embodiments relate to direct communication between mobile devices, including communication using Wi-Fi Aware techniques and/or Neighborhood Awareness Network (NAN) techniques. Some embodiments relate to contention based communication. Some embodiments relate to communication using paging time blocks.

### BACKGROUND

Mobile devices may communicate with a base station of a mobile network to exchange data, voice and other information. In some cases, it may be beneficial for a mobile device to communicate directly with other mobile devices. For instance, two mobile devices located in close proximity may communicate over a direct wireless link between the two devices. Such communication in device-to-device scenarios and other scenarios may be challenging, in some cases, and therefore there is a general need for methods and systems that address these scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments;

FIG. 4 illustrates the operation of a method of communication in accordance with some embodiments;

FIG. 5 illustrates an example of a paging Neighborhood Awareness Network Data Link (P-NDL) time block and a schedule of Neighborhood Awareness Network (NAN) time blocks in accordance with some embodiments; and

FIG. 6 illustrates the operation of another method of communication in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

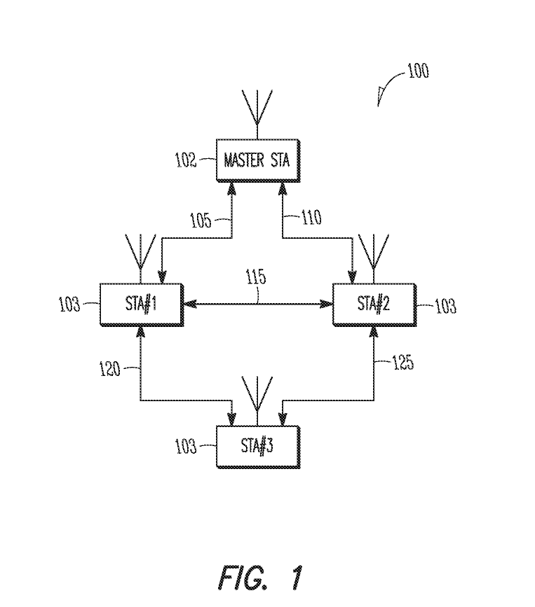

FIG. 1 illustrates a wireless network in accordance with some embodiments. In some embodiments, the network 100 may be a Wireless Local Area Network (WLAN) or a Wi-Fi network, although the scope of embodiments is not limited in this respect. It should be noted that embodiments are not limited to the number or type of components shown in the example network 100. Embodiments are also not limited by the example network 100 in terms of the arrangement of the components or the connectivity between components as shown. In addition, some embodiments may include additional components.

The example network 100 may include one or more master stations (STAs) 102 and one or more stations (STAs) 103. In some embodiments, the master STAs 102 and/or STAs 103 may be arranged to operate in accordance with one or more IEEE 802.11 standards. It should be noted that some embodiments may not necessarily include a master STA 102. In addition, in some embodiments, an STA 103 may be configurable to operate as a master STA 102 and/or as an STA 103. These embodiments are not limiting, however, as other mobile devices, portable devices and/or other devices, which may or may not be arranged to operate in accordance with a standard, may be used in some embodiments. As an example, a User Equipment (UE) arranged to operate in accordance with one or more Third Generation Partnership Project (3GPP) standards may be used in some cases.

In the example network 100, the STAs 103 may be configured to communicate with the master STA 102 and/or with other STAs 103. As shown in FIG. 1, STA #1 may communicate with the master STA 102 over the wireless link 105, STA #2 may communicate with the master STA 102 over the wireless link 110, and STA #1 and STA #2 may communicate directly with each other over the wireless link 115. In some embodiments, the communication between the master STA 102 and the STAs 103 and/or the communication between the STAs 103 may be performed using any suitable 802.11 standard (including legacy 802.11 standards). Such communication may also be performed in accordance with one or more Wi-Fi Aware and/or Neighborhood Awareness Network (NAN) standards, in some embodiments. These embodiments are not limiting, however, as other communication techniques and/or protocols may be used for the communication between the master STA 102 and the STAs 103 and/or the communication between the STAs 103, in some embodiments.

In accordance with some embodiments, STA #1 may transmit a data frame and/or data signal to STA #2 during a NAN time block allocated for NAN communication between a group of STAs 103 that includes STA #1 and STA #2. For instance, the NAN communication may include communication over a NAN Data Link (NDL) between STA #1 and STA #2. The transmission of the data frame and/or data signal may be performed in accordance with contention based access techniques, in some cases. These embodiments will be described in more detail below.

As a non-limiting example, two STAs 103 may communicate with each other although both may not necessarily communicate with the same master STA 102. For instance, one of the STAs 103 may be out of range of the master STA 102, and in some cases, may communicate with a different master STA 102. Referring to FIG. 1, STA #3 may communicate with STAs #1 and #2 over wireless links 120 and 125, despite being out of range of the master STA 102 (at least temporarily).

In some embodiments, the master STA 102 may perform one or more operations as part of a NAN communication, such as exchanging of control messages with the STAs 103 for an establishment of the NAN communication, providing a reference timing for the NAN communication and/or other management/control operations. However, embodiments are not limited to usage of a master STA 102 in the NAN communication, as NAN communication between STAs 103 may be performed with little or no involvement of the master STA 102. For instance, one of the STAs 103 may transmit synchronization signals to enable other STAs 103 to establish a common synchronization/timing, in some embodiments.

In some embodiments, the STAs 103 may be arranged to operate in accordance with a protocol and/or standard such as Wi-Fi Aware, NAN, Wi-Fi Aware 2.0, NAN2 and/or others to enable the STAs 103 to discover other STAs 103, devices and/or services that may be operating in a relatively close proximity. As an example, multiple STAs 103 may form a NAN data cluster (NDC) and may be synchronized to a same clock and/or a same reference timing. The STAs 103 may converge on a time period and channel included as part of a discovery window (DW) to facilitate the discovery of services of other STAs 103 and/or other devices. The discovery may be performed, in some cases, with little or no involvement from an access point (AP) or other infrastructure components, although embodiments are not limited as such. In some embodiments, one or more signals transmitted by an AP may be used by one or more STAs 103 to determine a reference timing and/or a schedule for a NAN communication. In some embodiments, one or more STAs 103 may exchange one or more control messages with an AP to at least partly enable a NAN communication. For instance, the NAN communication may be established based at least partly on a control message received from an AP, in some embodiments.

In some cases, STAs 103 and/or other devices may transmit data to each other with little or no involvement of an infrastructure. As an example, one STA in 103, say STA #1, may advertise time blocks for further availability called further availability window (FAW) in discovery window, and another STA in 103, say STA #2, may go to FAW and form a NAN Data link (NDL) with STA #1 to transmit data to each other. Each NDL may have an NDL schedule with specifically agreed time blocks, which may or may not be in the same channel. Furthermore, different NDLs, STAs 103 and/or other devices may form an NDC, and a common NDC base schedule may manage operation and/or communication between the STAs 103 in the NDC, in some cases.

In accordance with some embodiments, the STAs 103 and/or master STA 102 may be arranged to contend for a wireless medium (e.g., during a contention period) to receive exclusive control of the medium for a transmission period. For instance, the transmission period may include a transmission opportunity (TXOP), which may be included in an 802.11 standard and/or other standard. In some embodiments, a length of the transmission period may be variable. For instance, a length of the transmission period may be variable according to an amount of data that is to be sent, but may be bounded by a maximum permitted length (which may or may not be part of a standard). Accordingly, when a small amount of data is to be transmitted, a relatively small transmission period may be used. When a large amount of data is to be transmitted, a relatively large transmission period may be used and in some cases, the data may be divided and sent over multiple transmission periods in accordance with a maximum permitted length of the transmission period.

The data transmissions may be performed in accordance with any suitable multiple-access techniques and/or multiplexing techniques. Accordingly, one or more of orthogonal frequency division multiple access (OFDMA), orthogonal frequency division multiplexing (OFDM), code-division multiple access (CDMA), time-division multiple access (TDMA), frequency division multiplexing space-division multiple access (SDMA), multiple-input multiple-output (MIMO), multi-user (MU) multiple-input multiple-output (MIMO) (MU-MIMO) and/or other techniques may be employed in some embodiments.

In some embodiments, the STA 103 may communicate with other STAs 103 and/or the master STA 102 in accordance with legacy WEE 802.11 communication techniques. These embodiments are not limiting, however, as non-legacy IEEE 802.11 techniques or a combination of legacy and non-legacy IEEE 802.11 techniques may be used in some embodiments.

In some embodiments, channels used for communication between STAs 103 and/or master STAs 102 may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel may be configured for transmitting a number of spatial streams, in some embodiments. These embodiments are not limiting, however, as other suitable bandwidths may be used in some embodiments.

In some embodiments, high-efficiency wireless (HEW) techniques may be used, although the scope of embodiments is not limited in this respect. As an example, techniques included in 802.11 ax standards and/or other standards may be used. In such embodiments, an HEW packet may be generated in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

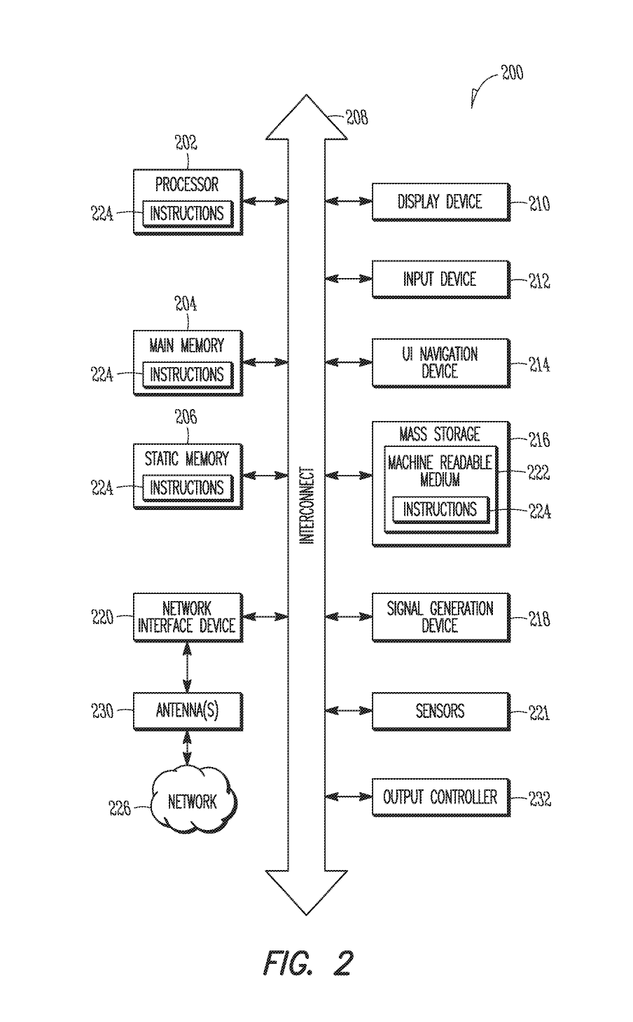

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be a master STA 102, STA 103, access point (AP), UE, eNB, mobile device, base station, personal computer (PC), a tablet PC, a set-top box (STB), a personal digital assistant (MAX a mobile telephone, a smart phone, a web appliance, a network router, switch or bridge, or any machine capable of executing instructions (sequential or otherwise that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium.

While the machine readable medium 222 is illustrated as a single medium, the term “machine readable medium” may include a single medium or multiple media (e.g., a centralized or distributed database; and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

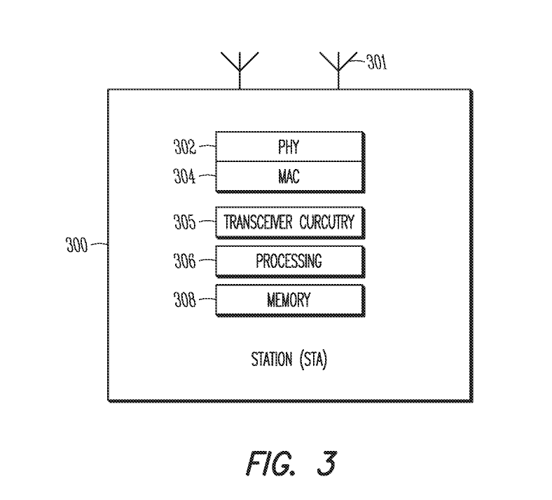

FIG. 3 illustrates a user station (STA) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. The STA. 300 may be suitable for use as a master STA 102 as depicted in FIG. 1, in some embodiments. Accordingly, references to an STA 300 are not limiting, and may be applicable to a master STA in some cases.

The STA 300 may include physical layer circuitry 302 and a transceiver 305, one or both of which may enable transmission and reception of signals to and from components such as the master STA 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control layer (MAC) circuitry 304 for controlling access to the wireless medium. The STA 300 may also include processing circuitry 306 and memory 308 arranged to perform the operations described herein.

The antennas 301, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 230 may be effectively separated to take advantage of spatial diversity and the different channel characteristics that may result.

In some embodiments, the STA 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 or other device may include one or more of a keyboard, a display, a non-volatile memory port, multiple antennas, a graphics processor, an application processor, speakers, and other mobile device elements. The display may be an LCD screen including a touch screen.

Although the STA 300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA.

In some embodiments, the STA 300 may communicate using OFDM communication signals over a multicarrier communication channel. Accordingly, in some cases the STA 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the embodiments is not limited in this respect as they may also be suitable to transmit and/or receive communications in accordance with other techniques and standards. In some other embodiments, the STA 300 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, channel resources may be used for transmissions of signals between STAs 103. Although embodiments are not limited as such, the transmissions may be performed in accordance with contention based techniques and/or time-division duplex (TDD) techniques in some cases. In some embodiments, the channel resources may include multiple channels, such as the 20 MHz channels previously described. The channels may include multiple sub-channels or may be divided into multiple sub-channels to accommodate multiple access for multiple STAs 103, in some cases. In some embodiments, the sub-channels may comprise a predetermined bandwidth. As a non-limiting example, the sub-channels may each span 2.03125 MHz, the channel may span 20 MHz, and the channel may include eight or nine sub-channels. However, any suitable frequency span for the channels and/or sub-channels may be used. In some embodiments, the frequency span for the sub-channel may be based on a value included in an 802.11 standard (such as 802.11ax), a 3GPP standard or other standard. In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

In accordance with some embodiments, an STA 103 may be configurable to operate as an originating STA 103. Accordingly, the originating STA 103 may transmit, during a paging window of a paging Neighborhood Area Network Data Link (P-NDL) time block, a paging message that indicates an intention of the originating STA 103 to transmit a data frame to a destination STA 103. The originating STA 103 may receive, during a transmission window of the P-NDL time block, a trigger frame (TF) from the destination STA 103 that indicates a request to receive the data frame from the originating STA 103. The originating STA 103 may determine a contention window (CW) size to be used for transmission of the data frame to the destination STA 103. The CW size may be determined based on other TFs exchanged between other STAs 103 during the transmission window in some embodiments. These embodiments will be described in more detail below.

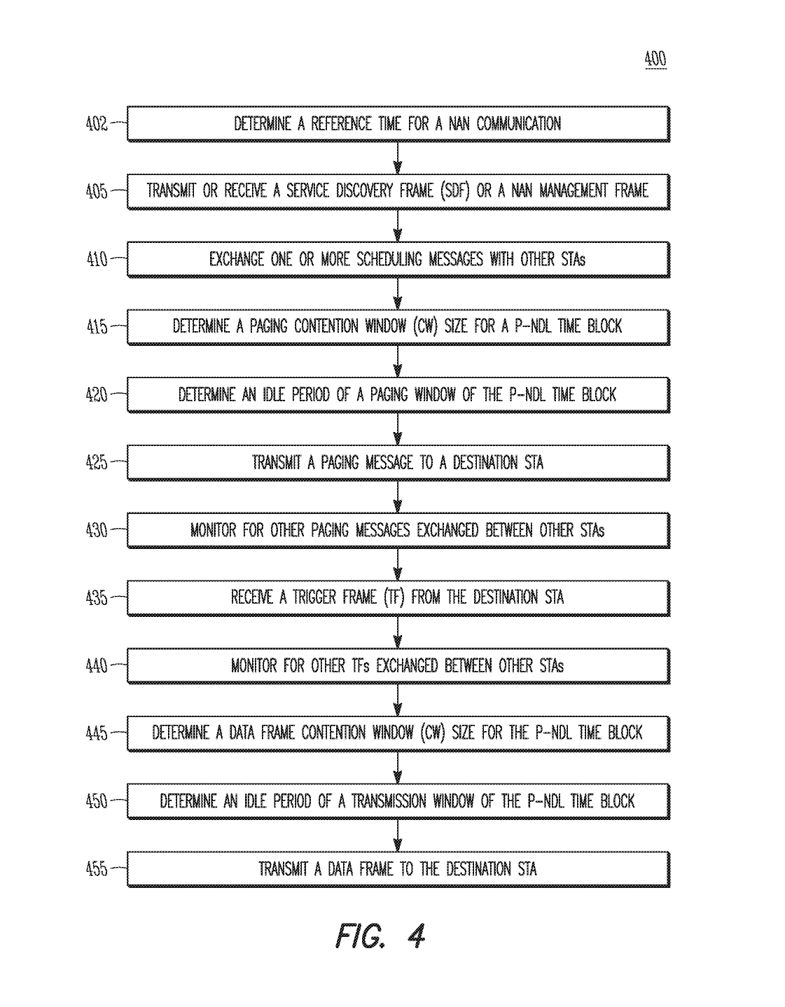

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-6, although it is understood that the method 400 may be practiced with any other suitable systems, interfaces and components.

In addition, while the method 400 and other methods described herein may refer to STAs 103 and/or master STAs 102 operating in accordance with 802.11 or other standards, embodiments of those methods are not limited to just those devices and may also be practiced on other mobile devices, such as an HEW STA, an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103 and/or master STA 102 or other device described above, in some embodiments.

It should also be pointed out that reference may be made herein to an “originating STA 103” and/or “destination STA 103.” For instance, an operation of the method 400, 600 and/or other methods described herein may include transmission of data signals and/or other signals from an originating STA 103 to a destination STA 103. These references are not limiting, however. In some embodiments, an STA 103 may be configured to perform operations described herein for either an originating STA 103, a destination STA 103 or both. 1.11 some embodiments, an STA 103 may be configurable to operate as either an originating STA 103 or as a destination STA 103 or as both. For instance, the STA 103 may perform one or more operations of an originating STA 103 as part of sending data to another STA 103 and may perform one or more operations of a destination STA 103 as part of receiving data from another STA 103.

In some embodiments, transmissions of messages, frames and/or signals may be performed over direct wireless (ink(s) between an originating STA 103 and one or more destination STA(s) 103. Although embodiments are not limited as such, the transmissions may be performed in accordance with a NAN protocol, in some embodiments. In some embodiments, a NAN communication and/or communication between the STA 103 and a master STA 102 may be performed in one or more channels. The channels may or may not be adjacent in frequency, and may span any suitable bandwidth including but not limited to the values described previously. As a non-limiting example, a group of 20 MHz channels may be used.

In some embodiments, a NAN communication may be based on time blocks. In some cases, one or more STAs 103 and/or devices may be synchronized for such a communication. For instance, a starting time of one or more time blocks in a pattern or sequence may be based on a reference timing determined by each of the STAs 103. In some cases, it is possible that multiple devices may start access in the same time block and may transmit packets. Hence, some contention mitigation scheme may be used for different types of time blocks, including but not limited to, paging NDL (P-NDL), FAW, NDC, and NDL time blocks.

In some embodiments, a P-NDL time block may be used for communication between STAs 103 (and/or other devices) that may be relatively infrequent. As a non-limiting example, a relatively small block of data may be communicated by a first STA 103 to a second STA 103 on an infrequent basis using a P-NDL time block while the first STA 103 may communicate a stream of data blocks to a third STA 103 using other types of NAN time blocks. Embodiments are not limited to usage of the P-NDL time blocks for communication of relatively small blocks of data or to communication on a relatively infrequent basis, however. In some cases, one or more P-NDL time blocks may be used for other types of communication which may or may not be infrequent. In some embodiments, an NDL may be established between the originating STA 103 and the destination STA 103. During a P-NDL time block, the originating STA 103 may contend for access to a channel/wireless medium in order to communicate with the destination STA 103 other over the NDL established between the originating STA 103 and the destination STA 103. It should be noted that the P-NDL time block may be used by other STAs 103 in some cases, such as for NDLs established between other pairs of STAs 103.

It should be noted that in some embodiments, the time blocks used in the method 400 and/or 600 may be any suitable type of time block, including but not limited to the P-NDL time block. In some embodiments, an NDL time block (which may be a time block for which the originating STA 103 and the destination STA 103 may communicate over an NDL between them) may be used.

It should be noted that reference may be made to a P-NDL time block in the description of the method 400, but embodiments are not limited as such. In some embodiments, one or more operations of the method 400 may be applicable to an NDC time block and/or other types of NDL time blocks. In addition, other time blocks that may not necessarily be included in a standard may be used in some embodiments.

In some embodiments, an FAW time block may be announced by a particular STA 103 to enable other STAs 103 to contact the particular STA 103 to establish a data link. In some embodiments, an NDC base schedule may include one or more NBC time blocks agreed to by all devices in the same NBC. An NDL schedule may include one or more NDL time blocks P-NDL time blocks and/or other types of NDL time blocks) to which two STAs 103 have agreed for NAN data transmission. In some cases, a same time block may be used by multiple devices for NAN communication.

It should also be noted that embodiments are not limited by references herein to transmission, reception and/or exchanging of frames and messages. In some embodiments, such a frame or message may be generated by processing circuitry for transmission. The transmission may be performed by a transceiver or other component, in some cases. In some embodiments, such a frame or message may be decoded, detected and/or processed by the processing circuitry. The frame or message may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

At operation 402 of the method 400, the originating STA 103 may determine a reference timing to be used for Neighborhood Awareness Network (NAN) communication with one or more other STAs 103. In some embodiments, the NAN communication may include a NAN Data Link (NDL) communication. In some embodiments, the NAN communication may include a NAN Data Cluster (NDC) communication, in which STAs 103 in an NDC may communicate with each other. In some embodiments, the NAN communication may include communication using one or more P-NDL time blocks and/or other NDL time blocks. Accordingly, the reference timing may be used by the STAs 103 to synchronize NAN communication. For instance, a starting time (or other time) of a particular time block, such as a discovery window (DW), further availability window (FAW), NDL time block, NDC time block, P-NDL time block and/or other time block may be based on the reference timing.

In some embodiments, the reference timing may be determined based on a reception of one or more synchronization signals and/or other signals from a master STA 102. Accordingly, multiple STAs 103 may receive those signals and/or other signals from the master STA 102, and the STAs 103 may synchronize for the NAN communication. These embodiments are not limiting, however, as other techniques may be used. For instance, a particular STA 103 may transmit one or more synchronization signals, beacon signals and/or other signals, and other STAs 103 may synchronize to a reference timing that the particular STA 103 wishes to establish. In some embodiments, the STAs 103 may synchronize to a common timing and/or schedule by exchanging signals with each other. In some cases, the signals may be exchanged at least partly to enable synchronization, although embodiments are not limited as such. In some embodiments, the signals may not necessarily have been transmitted for purposes of enabling the synchronization.

It should also be pointed out that in some embodiments, the STAs 103 may exchange one or more control signals with the master STA 102 as part of the establishment of the NAN communication. For instance, control information for the NAN communication may be received from the master STA 102, such as which channels are available and/or unavailable for the NAN communication. Embodiments are not limited as such, however, as STAs 103 may exchange and/or broadcast such control signals in some embodiments. For instance, in some cases, a master STA 102 may not be used.

At operation 405, the originating STA 103 may exchange one or more signals with one or more destination STAs 103 during a discovery window (DW). As an example, the originating STA 103 may transmit a service discovery frame (SDF) or a NAN management frame during the DW. The SDF may announce a capability of the originating STA 103 (such as a capability for NAN operation by the originating STA 103 or other capability), an availability of the originating STA 103 to provide a service (which may or may not be related to NAN operation) and/or other related information. The NAN management frame may be related to a NAN data link (NDL) communication, a NAN data cluster (NDC) communication, a NAN communication using one or more P-NDL time blocks and/or other NAN communication, in some cases. As another example, the originating STA 103 may receive an SDF and/or NAN management frame during the DW. In some embodiments, the DW may include a time block allocated on a particular channel to enable STAs 103 to discover services of each other. For instance, the discovery may be performed by the STAs 103 using direct communication between STAs 103, in which the access points (APs) and/or other infrastructure components may have no involvement or limited involvement, in some cases.

At operation 410, the originating STA 103 may exchange one or more scheduling messages with one or more other STAs. In some embodiments, the scheduling messages may be exchanged during a further availability window (FAW), which may include a time block allocated on a particular channel subsequent to the DW, to enable STAs 103 to negotiate a schedule for NAN communication. Accordingly, the originating STA 103 may transmit and/or receive one or more scheduling messages from one or more other STAs 103. As a non-limiting example, such scheduling messages may include information related to a schedule of P-NDL time blocks for the NAN communication, including but not limited to times and/or channels of allocated P-NDL time blocks, frequency of occurrence of P-NDL time blocks, positions of P-NDL time blocks within a schedule and/or other information that may enable STAs 103 to determine times and/or channels of P-NDL time blocks.

In some embodiments, the scheduling messages may be transmitted in accordance with a contention based access during the FAW. As will be described below, other transmissions during other time blocks may be performed in accordance with other contention based access operations that may or may not be related to contention based access operations performed during the FAW. For instance, contention windows (CWs), back-off counts and/or other parameters used during the FAW may not necessarily be related to similar parameters used in other time blocks, in some cases.

At operation 415, the originating STA 103 may determine a paging contention window (CW) size for a P-NDL time block. At operation 420, the originating STA 103 may determine an idle period of a paging window of the P-NDL time block. In some embodiments, the originating STA 103 may detect the idle period. At operation 425, the originating STA 103 may transmit a paging message to one or more destination STAs 103. Although embodiments are not limited as such, the paging message may be transmitted during the paging window in some embodiments.

In some embodiments, the paging message may be transmitted in accordance with a paging back-off count that may be selected randomly according to the determined paging CW size. For instance, the transmission of the paging message may be delayed by at least the paging back-off count with respect to an ending time of the idle period of the paging window. It should be noted that in embodiments described herein, a transmission of a message (including but not limited to the paging message and/or frame including but not limited to a trigger frame (TF) and/or data frame) in accordance with a back-off count is not limited to usage of the back-off count as the delay. In some embodiments, other delays related to the back-off count may be used. As non-limiting examples of such, the transmission may be delayed by at least the back-off count or may be delayed by a value that is approximately equal to the back-off count. It should also be noted that in some embodiments, the back-off count may be determined based at least partly on a previous back-off count. For instance, a back-off count (or at least a portion of it) may be carried over from a previous time block for usage as the back-off count for a first chronological transmission in the current time block.

In some embodiments, the back-off count may be drawn (for instance, determined randomly or pseudo-randomly) from an interval that spans a range of values up to the CW size. As an example, the CW size may be given in terms of a number of time slots, time intervals, time units (microseconds, milliseconds, seconds and/or other unit) in some cases. For instance, the range of values from which the back-off count is selected may span from a single time unit up to CW time units. Any suitable selection method may be used, including but not limited to uniform selection within the range of values.

In some embodiments, the usage of an idle period detection, a CW, a back-off count, transmission delay and/or other concepts for contention based access may be performed in accordance with a carrier sense multiple access with collision avoidance (CSMA/CA) protocol. As an example, the CSMA/CA protocol may be included in an 802.11 standard and/or other standard, in some cases, although embodiments are not limited to usage of CSMA/CA techniques that are included in a standard.

In some embodiments, CW sizes described herein may be selected from a group of values. Any suitable group of values may be used. As a non-limiting example, the group of values may include one or more integers of the form 2̂n−1, in which “n” may be restricted to integers greater than 1. In some cases, the group of values may be restricted to integers of that form and may be further restricted to a particular set of values for “n”. For instance, the group of values may include and/or may be restricted to 3, 7, 15, 31, 63, 127, and 255 (in which case “n” takes values in the range of 2-8). This group of values may be included as part of an 802.11 standard and/or other standard, in some cases, although embodiments are not limited as such. This example is not limiting in terms of the size of the group, the formula to determine the values in the group and/or other aspects. In some embodiments, the values in the group may not necessarily be describable and/or determinable by a formula (such as 2̂n−1 or other formula).

In some embodiments, the paging message may indicate that the originating STA 103 intends to transmit one or more data frames to a destination STA 103. Such a paging message may be a uni-cast message intended for the destination STA 103 in some cases. In some embodiments, the paging message may indicate that the originating STA 103 intends to transmit the one or more data frames to the destination STA 103 and one or more other STAs 103 (or in some cases, to multiple destination STAs 103). Such a paging message may be a multi-cast message intended for the multiple STAs 103 in some cases.

In some embodiments, the originating STA 103 may perform operations such as channel sensing, bandwidth sensing, spectrum analysis, signal energy detection, decoding of packets or others to determine and/or detect the idle period of the channel. Accordingly, the STA 103 may determine whether a channel is idle based on monitoring of activity of other STAs 103, master STAs 102, APs and/or other devices, in some cases. As an example, when transmission activity is detected, the channel (wireless medium) may be determined to be busy or unavailable for the intended data transmission by the originating STA 103.

In some embodiments, the originating STA 103 may monitor the channel for a particular time period to determine whether the channel is idle. As a non-limiting example, various inter-frame spacing (IFS) included in 802.11 standards may be used, such as an xIFS, short IFS (SIFS) and/or other. Embodiments are not limited to the usage of an IFS, however, as any suitable interval, which may or may not be included in a standard, may be used in some embodiments. In some embodiments, a minimum length of the determined idle period of the paging window (and/or an IFS to be used for the paging window) may be based at least partly on whether the paging message is a uni-cast paging message or a multi-cast paging message. For instance, the minimum length and/or IFS may be lower for multi-cast paging messages than for uni-cast paging messages.

Non-limiting examples of techniques that may be used as part of the determination of the paging CW size are presented below, although any suitable techniques may be used. For instance, a default value, initial value and/or other value (which may or may not be included in a standard) may be used in some cases. In some embodiments, the paging CW size may be determined based at least partly on a traffic type of the data frame(s) of the paging message. As a non-limiting example, the traffic type of the data packets may be one of a group of Enhanced Distributed Channel Access Function (EDCAF) traffic types that includes background, best effort, video and voice. These example EDCAF traffic types are not limiting, however, as other types may be used in some cases, including but not limited to data, management, control and/or other suitable types. For instance, in some cases, latency requirements for voice traffic may be lower than for background traffic, and therefore a lower paging CW size may be used for voice traffic than for background traffic. It should be noted that embodiments are not limited to EDCAF traffic types or to traffic types included in a standard.

In some embodiments, the paging CW size may be based at least partly on a number of STAs 103 in a NAN data cluster and/or a number of STAs 103 that have been detected to be operating in the vicinity of the originating STA 103. Embodiments are not limited to NDCs, however, as the paging CW size may be based at least partly on a number of STAs 103 in any suitable group, such as a group of STAs 103 configured to perform NAN communication.

As an example, the originating STA 103 and the destination STA 103 may be included in a NAN data cluster (NDC) of two or more STAs 103 One or more P-NDL time blocks NDC time blocks and/or other NAN time blocks may be allocated for a NAN communication between one or more STAs 103 included in the NDC. The paging CW size may be determined at least partly based on a size of the NDC in some cases. For instance, when the number of STAs 103 in the NDC is relatively low, a low value of the paging CW size may be used. For a higher number of STAs 103 in the NDC, a higher value of the paging CW size may be used.

In some embodiments, the paging CW size may be based at least partly on whether the paging message is a uni-cast message or a multi-cast message. That is, the number of STAs 103 to which the data frame(s) are to be transmitted may be used as part of the determination of the paging CW size, in some cases. As a non-limiting example, the paging CW size may be lower for multi-cast paging messages than for uni-cast paging messages.

It should be noted that embodiments are not limited to the example techniques described for the determination of the paging CW size. In addition, the determination of the paging CW size may include usage of one or any combination of the techniques described above and/or other techniques, in some embodiments. It should also be noted that one or more of the techniques described herein for determination of the paging CW size may be used for other CW sizes (such as a TF CW size, data frame CW size and/or others) in some embodiments.

It should also be noted that in some embodiments, operations such as selection of a back-off count, determination of an idle period, delaying a transmission according to the back-off count and/or other operations may be applicable to other data transmissions using a CW size other than the paging CW size determined at operation 415. As an example, the originating STA 103 may perform a group of one or more data transmissions to one or more destination STAs 103 during the P-NDL time block. The paging CW size determined at operation 415 may be used for a first chronological (earliest) data transmission in the group, and other data transmissions may be performed in accordance with other CW sizes. As an example, a first CW size used for the first chronological data transmission may be increased or decreased to generate a second CW size (to be used for a second chronological data transmission) based on whether the first data transmission is successful or not. For instance, exponential back-off techniques and/or other techniques may be used, in some cases. As another example, the second CW size may be reset to a target CW size when the first data transmission is successful. These examples are not limiting, however, as any suitable techniques may be used to determine subsequent CW sizes based on an earlier CW size.

Returning to the method 400, the originating STA 103 may monitor for other paging messages exchanged between other STAs 103 during the paging window at operation 430. In some embodiments, the originating STA 103 may determine a number of potential contending data transmissions for a transmission window of the P-NDL time block (subsequent to the paging window). In some embodiments, the originating STA 103 may decode one or more control blocks of the paging messages exchanged between the other STAs 103. Accordingly, information about potential (and/or intended) data transmissions by other STAs 103, such as a number of data transmissions, types of data transmissions and/or other information, may be determined by the originating STA 103 based on the decoded control blocks.

At operation 435, the originating STA 103 may receive a TF from the destination STA 103 during the transmission window of the P-NDL. Although embodiments are not limited as such, the transmission window may be subsequent to the paging window in the P-NDL, in some embodiments. In some embodiments, the TF may indicate a request by the destination STA 103 to receive a data frame from the originating STA 103. As a non-limiting example, the TF may be transmitted in response to the paging message transmitted by the originating STA 103.

At operation 440, the originating STA 103 may monitor for other TFs exchanged between other STAs 103 during the transmission window. As previously described regarding the monitoring for paging messages exchanged between other STAs 103, the originating STA 103 may determine information about potential and/or intended data transmissions of other STAs 103, such as a number and/or types of data transmission requests by other STAs 103, a number and/or types of potential colliding data transmissions and/or other information. For instance, one or more control blocks of the TFs may be decoded in some cases to determine such information.

At operation 445, the originating STA 103 may determine a data frame contention window (CW) size for the P-NDL, time block. As an example, the data frame CW size may be determined for usage in a transmission of one or more data frames to the destination STA 103 during the transmission window of the P-NDL. As an example, the paging message transmitted at operation 425 may indicate an intention of the originating STA 103 to transmit such data frames to the destination STA 103. It should also be noted that transmission to multiple STAs 103 may be used in some cases, such as in a multi-cast scenario. Examples of suitable techniques that may be used for the determination of the data frame CW size are presented below.

At operation 450, the originating STA 103 may determine an idle period of the transmission window of the P-NDL time block. In some embodiments, the originating STA 103 may detect the idle period. Although embodiments are not limited as such, one or more previously described techniques regarding the determination and/or detection of the idle period of the paging window of the P-NDL time block at operation 420 may be used. It should be noted that the idle period may be determined and/or detected at operation 450 as part of a contention based transmission of the data frames. In some embodiments, a minimum length of the idle period of operation 450 may or may not be related to the minimum length of the idle period of operation 420. For instance, different values of an IFS may be used and/or specified, in some cases.

At operation 455, the originating STA 103 may transmit the one or more data frames to the destination STA 103. Previously described techniques regarding contention based transmission in accordance with a randomly selected back-off count may be used, although embodiments are not limited as such. As an example, the originating STA 103 may select a data frame back-off count randomly according to the data frame CW size and the transmission of the data frame may be delayed by at least the data frame back-off count with respect to an ending time of the idle period of the transmission window.

It should be noted that the originating STA 103 may transmit one or more data frames to multiple STAs 103 in a multi-east scenario. Although embodiments are not limited as such, the data frame(s) may be transmitted during the transmission window and subsequent to the reception of the TF, in some embodiments. In addition, the data frame(s) may be transmitted in response to the reception of the TF in some cases.

Non-limiting examples of techniques that may be used as part of the determination of the data frame CW size are presented below, although any suitable techniques may be used. In some cases, techniques that may be similar to those used for the determination of the paging CW size may be used, although embodiments are not limited as such. In some cases, a default value, initial value and/or other value (which may or may not be included in a standard) may be used.

In some embodiments, the data frame CW size may be determined based at least partly on a traffic type of the data frame(s) to be transmitted. As a non-limiting example, the traffic type of the data packets may be one of a group of Enhanced Distributed Channel Access Function (EDCAF) traffic types that includes background, best effort, video and voice. These example EDCAF traffic types are not limiting, however, as other types may be used in some cases, including but not limited to data, management, control and/or other suitable types. For instance, in some cases, latency requirements for voice traffic may be lower than for background traffic, and therefore a lower data frame CW size may be used for voice traffic than for background traffic. It should be noted that embodiments are not limited to EDCAF traffic types or to traffic types included in a standard.

In some embodiments, the data frame CW size may be based at least partly on a number of STAs 103 in a NAN data cluster and/or a number of STAs 103 that have been detected to be operating in the vicinity of the originating STA 103. Embodiments are not limited to NDCs, however, as the data frame CW size may be based at least partly on a number of STAs 103 in any suitable group, such as a group of STAs 103 configured to perform NAN communication. For instance, when the number of STAs 103 in the NDC is relatively low, a low value of the data frame CW size may be used. For a higher number of STAs 103 in the NDC, a higher value of the data frame CW size may be used.

In some embodiments, the data frame CW size may be determined based at least partly on information determined as part of the monitoring of other TFs exchanged between other STAs 103 at operation 440. For instance, a number and/or type of data transmission requests by other STAs 103 may be used by the originating STA 103 as part of the determination of the data frame CW size, in some cases.

It should be noted that embodiments are not limited to the example techniques described for the determination of the data frame CW size. In addition, the determination of the data frame CW size may include usage of one or any combination of the techniques described above and/or other techniques, in some embodiments. It should also be noted that one or more of the techniques described herein for determination of the data frame CW size may be used for other CW sizes (such as a TF CW size, paging CW size and/or others) in some embodiments.

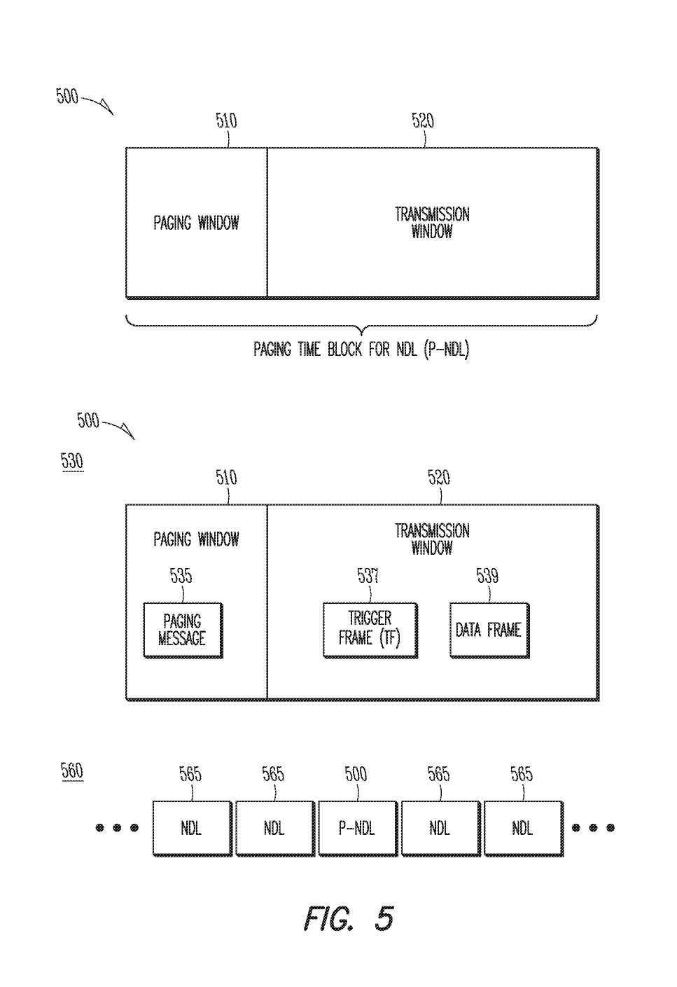

FIG. 5 illustrates an example of a paging Neighborhood Awareness Network Data Link (P-NDL) time block and a schedule of Neighborhood Awareness Network (NAN) time blocks in accordance with some embodiments. It should be noted that the examples 500, 530, 560 shown in FIG. 5 may serve to illustrate some or all of the concepts and techniques described herein, but embodiments are not limited to those example scenarios. For instance, embodiments are not limited to the number, type, ordering or arrangement of time windows, time blocks, messages and/or frames as shown in FIG. 5. Embodiments are also not limited to the number of messages and/or frames in each window as shown in FIG. 5. It should also be noted that P-NDL time blocks are shown in the example of FIG. 5, but embodiments are not limited as such. Other time blocks, such as NDL time blocks, NDC time blocks and/or other time blocks may be used in some embodiments.

The example P-NDL 500 may include a paging window 510 during a first portion and a transmission window 520 during a second, subsequent portion. The windows 510, 520 may be adjacent and non-overlapping in time, in some embodiments, although the scope of embodiments is not limited in this respect. As shown in the example scenario 530, a paging message 535 may be transmitted by the originating STA 103 and may indicate that the originating STA 103 intends to transmit one or more data frames to the destination STA 103. The destination STA 103 may transmit a TF 537 to indicate an intention to receive data (including but not limited to the data indicated by the paging message 535) from the originating STA 103. The data frame 539 may be transmitted by the originating STA 103 to the destination STA 103. The transmission of the paging message, TF 537 and/or the data frame 539 may be performed in accordance with techniques described herein for contention based access, although the scope of embodiments is not limited in this respect. As an example, the P-NDL 500 may be included in a sequence of time blocks 560, which may include one or more other types of time blocks, including but not limited to the NDL time blocks 565 shown in FIG. 5.

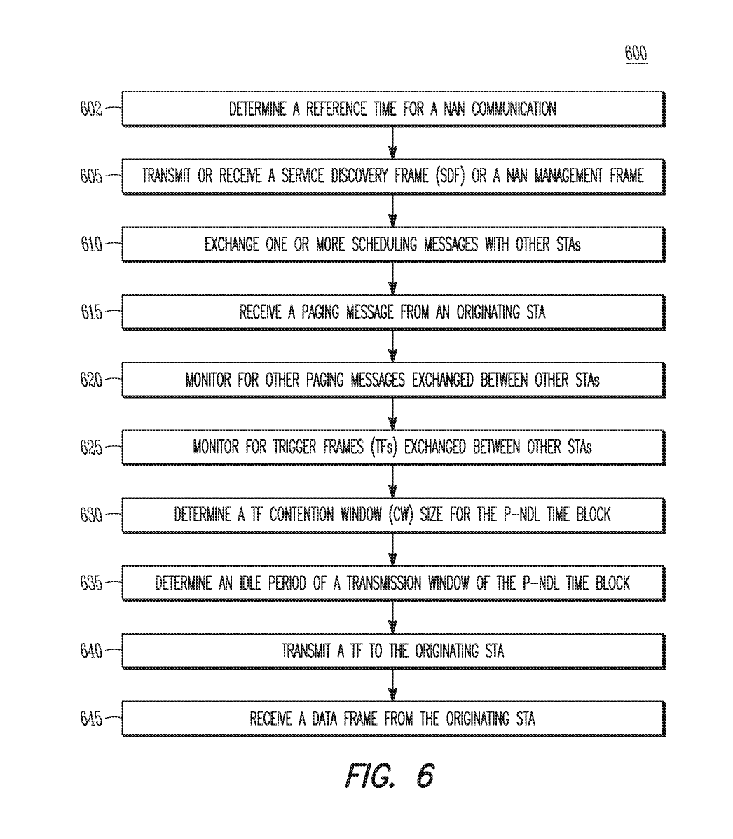

FIG. 6 illustrates the operation of another method of communication in accordance with some embodiments. As mentioned previously regarding the method 400, embodiments of the method 600 may include additional or even fewer operations or processes in comparison to what is illustrated in FIG. 6 and embodiments of the method 600 are not necessarily limited to the chronological order that is shown in FIG. 6. In describing the method 600, reference may be made to FIGS. 1-5, although it is understood that the method 600 may be practiced with any other suitable systems, interfaces and components. In addition, embodiments of the method 600 may refer to STAs 103, master STAs 102, UEs, eNBs and/or other wireless or mobile devices. The method 600 may also refer to an apparatus for a STA 103, master STA 102 and/or other device described above.

It should be noted that the method 600 may be practiced at a destination STA 103 and may include exchanging of signals or messages with an originating STA 103. Similarly, the method 400 may be practiced at an originating STA 103 and may include exchanging of signals or messages with a destination STA 103. In some cases, operations and techniques described as part of the method 400 may be relevant to the method 600. In addition, embodiments may include operations performed at the destination STA 103 that may be reciprocal or similar to other operations described herein performed at the originating STA 103. For instance, an operation of the method 600 may include reception of a message by the destination STA 103 while an operation of the method 400 may include transmission of the same message or similar message by the originating STA 103.

In addition, previous discussion and/or other discussion herein of various techniques and concepts may be applicable to the method 600 in some cases, including NAN, NDL, NDC, P-NDL, paging window, transmission window, time blocks, P-NDL time blocks, paging message, TF, data frames, originating STA, destination STA, CW, back-off count, idle period, CSMA/CA, reference timing and/or others. In addition, some or all aspects of the examples shown in FIG. 5 may be applicable in some cases. In addition, as previously described regarding the method 400, references to an “originating STA 103” and/or “destination STA 103” are not limiting. In some embodiments, an STA 103 may be configurable to operate as either an “originating STA 103” and/or “destination STA 103” and/or both. Accordingly, in some embodiments, an STA 103 may be configured to perform operations described herein for either an originating STA 103, a destination STA 103 or both.

At operation 602, the destination STA 103 may determine a reference time for a NAN communication. At operation 605, the destination STA may transmit or receive one or more SDFs and/or NAN management frames with one or more other STAs 103 and/or master STAs 102. At operation 610, the destination STA 103 may exchange one or more scheduling messages with other STAs 103.

At operation 615, the destination STA 103 may receive a paging message from an originating STA 103. In some embodiments, the paging message may be received during a paging window of a P-NDL time block, although embodiments are not limited as such. In some embodiments, the paging message may indicate that the originating STA 103 intends to transmit one or more data frames to the destination STA 103. At operation 620, the destination STA 103 may monitor for other paging messages exchanged between other STAs 103 during the paging window. At operation 625, the destination STA 103 may monitor for trigger frames (TFs) exchanged between other STAs 103 during a transmission window of the P-NDL time block.

At operation 630, the destination STA 103 may determine a TF contention window (CW) size. Examples of techniques that may be used to determine the TF CW size will be presented below. At operation 635, an idle period of the transmission window (which may be referred to as a TF idle period) may be determined for usage in a transmission of a TF by the destination STA 103. In some embodiments, the idle period may be detected by the destination STA 103. A TF may be transmitted to the originating STA 103 at operation 640. At operation 645, the destination STA 103 may receive one or more data frames (including but not limited to data frames related to the paging message received by the destination STA 103 and/or TF transmitted by the destination STA 103) from the originating STA 103.

In some embodiments, the TF may be transmitted using contention based access techniques such as those described herein, although embodiments are not limited as such. As an example, the TF may be transmitted to the originating STA 103 in accordance with a TF back-off interval selected randomly according to the determined TF CW size. For instance, the transmission of the TF may be delayed by at least the TF back-off interval with respect to an ending time of the TF idle period of the transmission window.

In some embodiments, the TF may indicate an intention of the destination STA 103 to receive one or more data frames from the originating STA 103. Such data frames may have been indicated in the paging message received at operation 615, although embodiments are not limited as such. At operation 645, the destination STA 103 may receive one or more data frames from the originating STA 103, including but not limited to data frames related to the paging message received by the destination STA 103 and/or TF transmitted by the destination STA 103.

As a non-limiting example, the TF CW size may be determined based at least partly on the monitoring for the other paging messages exchanged between the other STAs 103 during the paging window. For instance, the destination STA 103 may decode one or more control blocks of the other paging messages exchanged between the other STAs 103 during the paging window to determine and/or estimate) a number of data transmission notifications by the other STAs 103. The determination of the TF CW size in this case may be further based at least partly on the number of data transmission notifications.

As another non-limiting example, the originating STA 103 may determine, based at least partly on the decoded control blocks, one or more traffic types for the data transmission notifications. The TF CW size may be further based at least partly on the determined traffic types of the data transmission notifications. For instance, the traffic types may be EDCAF traffic types and/or other traffic types.

As another non-limiting example, the originating STA 103 and the destination STA 103 may be included in a NAN data cluster (NDC) of two or more STAs 103. The determination of the TF CW size may be further based at least partly on a number of STAs 103 included in the NEW, in some cases.

It should be noted that embodiments are not limited to these examples of determination of the TF CW size. Some embodiments may use any or all of the techniques described in these examples and/or other techniques. Some embodiments may use a combination of these example techniques may be used, in some embodiments.

In some embodiments, messages such as the paging message, data frame and/or others may be transmitted in accordance with acknowledgement techniques. Accordingly, a successful reception indicator for a transmitted message/frame may be determined. In some embodiments, the originating STA 103 may receive, or attempt to receive, an acknowledgement message from the destination STA 103. As an example, the reception of the acknowledgement message at the originating STA 103 may be unsuccessful. Accordingly, it may be determined that the transmission of the message/frame was unsuccessful (or at least it may be determined that a retransmission of the message/frame is to be performed). As another example, the acknowledgement message may be received at the originating STA 103 and may indicate that the destination STA 103 failed to decode one or more data packets transmitted as part of the message/frame. Accordingly, the transmission of the message/frame may be determined to be (at least partly) unsuccessful and it may be determined that a retransmission is necessary. As another example, the acknowledgement message may be received at the originating STA 103 and may indicate that the data packets transmitted as part of the transmitted message/frame were decoded successfully at the destination STA 103. Accordingly, the transmission may be determined to be successful. Based at least partly on the successful reception indicator, the originating STA 103 may select an update CW size for a retransmission of the message/frame or for a transmission of another message/frame. In some cases, the updated CW size may be based on the first CW size. As an example, the updated CW size may be lower than or higher than the first CW size based at least partly on the successful reception indicator, in some cases.

In some embodiments, one or more contention mitigation methods may be used as part of a NAN communication. Several non-limiting examples will be presented below. It should be noted that some embodiments may use one or more of the contention mitigation methods described below and/or a combination thereof. Some embodiments may use one or more operations from one or more of the contention mitigation methods described below. In addition, some embodiments may use additional operations (including but not limited to those described herein) in addition to one or more operations from one or more of the contention mitigation methods described below. In addition, some embodiments of contention mitigation methods described herein may be applicable to paging NDL (P-NDL) time blocks, but embodiments are not limited to P-NDL time blocks. Accordingly, in some embodiments, other time blocks that may or may not be related to NAN communication may be used.

In some embodiments, a combination of contention mechanisms may be used. In some cases, the devices (such as STAs 103) in the same NAN cluster may use the same contention mechanism or the same combination of mechanisms. In some embodiments, a back-off procedure may be performed for a first transmission of a time block even if the medium is idle for a fixed duration. That is, the STAs 103 may refrain from skipping the back-off for the first transmission of the time block, in some cases. In some embodiments, the back-off procedure and/or parameters of it (such as the CW size, back-off count and/or others) used in a transmission window of a P-NDL may be independent of the back-off procedure and/or parameters used in a paging window of the P-NDL. As an example, the STA 103 may reset a CW from the paging window to generate another CW for the transmission window, and may redraw a back-off count in the transmission window.

In some embodiments, a uni-cast paging message and a multi-cast paging message may operate in accordance with a different fixed deferral duration (such as a minimum idle period). For instance, an xIFS, other IFS and/or other time period may be used. It should be noted that such time periods may or may not be part of an 802.11 standard or other standard, in some cases. In some embodiments, a multi-cast paging message may have a shorter fixed deferral time than a uni-cast paging message. In some embodiments, a uni-cast paging message and a multi-cast paging message may have different CW from which to draw a random back-off count. In some embodiments, a CW may be chosen for a paging message based on one or any combination of factors such as a known number of STAs 103 that have used and/or may use the P-NDL/NDL, a defined value in a standard, a traffic type category (including but not limited to types included in an EDCAF protocol) and/or other factors. In some embodiments, a rule may be used for the chosen CW based on a value in a standard. For instance, the chosen CW may be restricted to be larger than the value in the standard.

In some embodiments, there may or may not be transmission failure for a data transmission, as a transmitting STA 103 may or may not solicit an acknowledgement of a data transmission from a specific STA 103, in some cases. If there are no transmission failures, the transmitting STA 103 may refrain from usage of an exponential back-off, in some cases. If there are transmission failures for paging message, the STA 103 may draw aback-off count from an enlarged CW. As a non-limiting example, the enlarged CW may be determined according to an exponential back-off (such as in a DCF mechanism).

In some embodiments, TF transmission and/or data transmission may be based on EDCAF techniques. An initial CW of an access category used for trigger frame transmission or data frame transmission may be different from a minimum CW parameter (such as CWmin and/or other) used in EDCAF. The initial CW of an access category used for TF transmission may consider a number of different/same devices that are paged in a paging window. In some cases, the STA 103 may know, determine and/or estimate this information by decoding each paging message (or at least a portion of them) in the same NAN cluster/NDC in paging window. In some cases, the CW may be restricted to be at least larger than the number of devices that are determined. The CW may be chosen as a valid value of EDCAF CW, in some cases. In some embodiments, the initial CW of an access category used for trigger frame transmission or data frame transmission may be predefined/suggested in a standard. In some cases, a restriction may be enforced for the chosen initial CW and the defined value in the spec. For instance, the chosen CW may be restricted to be be larger than the defined value in a standard.

In some embodiments, transmission failure or success operation for trigger frame transmission or data frame transmission may be used in accordance with EDCAF techniques for updating the CW. The initial CW of an access category for a data frame triggered by a trigger frame may consider any or all of the following information: a number of devices that are triggered by the trigger frame, a number of devices that are triggered by trigger frame plus a number of different/same devices paged in paging window, a number of devices that are triggered by the trigger frame in the transmission window so far (or up until a certain time) plus the number of different/same devices paged in the paging window. The initial CW of an access category for a data frame triggered by a trigger frame may use the CW defined by EDCA, in some cases.

In Example 1, an apparatus for a station (STA) may comprise memory and processing circuitry. The STA may be configurable to operate as an originating STA. The processing circuitry may be configured to generate a paging message for transmission to a destination STA during a paging window of a paging Neighborhood Area Network Data Link (P-NDL) time block. The processing circuitry may be further configured to decode a trigger frame (TF) that indicates a request to receive a data frame from the originating STA, the TF received from the destination STA during a transmission window of the P-NDL time block. The processing circuitry may be further configured to monitor for other TFs exchanged between other STAs during the transmission window. The processing circuitry may be further configured to determine, based at least partly on the other TFs, a data frame contention window (CW) size for a contention based transmission of the data frame by the originating STA.

In Example 2, the subject matter of Example 1, wherein the processing circuitry may be further configured to detect an idle period of the transmission window. The processing circuitry may be further configured to select a data frame back-off count randomly according to the data frame CW size. The processing circuitry may be further configured to generate the data frame for transmission to the destination STA delayed by at least the data frame back-off count with respect to an ending time of the idle period of the transmission window.

In Example 3, the subject matter of one or any combination of Examples 1-2, wherein the paging message and the data frame may be generated for transmission to the destination STA over a direct wireless link between the originating STA and the destination STA in accordance with a Neighborhood Area Network (NAN) protocol.

In Example 4, the subject matter of one or any combination of Examples 1-3, wherein the processing circuitry may be further configured to detect one or more TFs exchanged between the other STAs and decode one or more control blocks of the TFs exchanged between the other STAs to determine a number of data transmission requests by the other STAs. The data frame CW size may be based at least partly on the number of data transmission requests.

In Example 5, the subject matter of one or any combination of Examples 1-4, wherein the processing circuitry may be further configured to determine, based at least partly on the decoded control blocks, one or more traffic types for the data transmission requests. The data frame CW size may be further based at least partly on the determined traffic types of the data transmission requests.

In Example 6, the subject matter of one or any combination of Examples 1-5, wherein the determined traffic types for the data transmission requests may be in a group of Enhanced Distributed Channel Access Function (EDCAF) traffic types that includes background, best effort, video and voice.

In Example 7, the subject matter of one or any combination of Examples 1-6, wherein the data frame CW size is a first data frame CW size, the data frame is a first data frame, and the data frame back-off count is a first data frame back-off count. The processing circuitry may be further configured to determine a successful reception indicator for the first data frame based at least partly on an attempted reception of an acknowledgement message from the destination STA. The processing circuitry may be further configured to determine, a second data frame CW size based on the first data frame CW size and the successful reception indicator. The processing circuitry may be further configured to determine that the first data frame is to be retransmitted to the destination STA in accordance with a second data frame back-off count selected randomly according to the second data frame CW size or generate a second data frame for transmission to the destination STA in accordance with the second data frame back-off count.

In Example 8, the subject matter of one or any combination of Examples 1-7, wherein the processing circuitry may be further configured to monitor for other paging messages exchanged between other STAs during the paging window to determine a number of potential contending data transmissions for the transmission window. The data frame CW size may be based at least partly on the determined number of potential contending data transmissions.

In Example 9, the subject matter of one or any combination of Examples 1-8, wherein the processing circuitry may be further configured to detect an idle period of the paging window and select a paging back-off count randomly according to a paging CW size. The transmission of the paging message may be delayed by at least the paging back-off count with respect to an ending time of the idle period of the paging window.

In Example 10, the subject matter of one or any combination of Examples 1-9, wherein the paging message may indicate that the originating STA intends to transmit the data frame to the destination STA. The processing circuitry may be further configured to determine the paging CW size based at least partly on a traffic type of the data frame.

In Example 11, the subject matter of one or any combination of Examples 1-10, wherein the traffic type of the data frame may be one of a group of Enhanced Distributed Channel Access Function (EDCAF) traffic types that includes background, best effort, video and voice.

In Example 12, the subject matter of one or any combination of Examples 1-11, wherein the originating STA and the destination STA may be included in a NAN data cluster (NDC) of two or more STAs. The P-NDL time block may be allocated for paging based communication between the STAs in the NDC. The processing circuitry may be further configured to determine the paging CW size based at least partly on a number of STAs included in the NDC.

In Example 13, the subject matter of one or any combination of Examples 1-12, wherein a minimum length of the idle period of the paging window may be based at least partly on whether the paging message is a uni-cast paging message intended for the destination STA or a multi-cast paging message intended for the destination STA and one or more additional STAs. The minimum length of the idle period may be lower for multi-cast paging messages than for uni-cast paging messages.

In Example 14, the subject matter of one or any combination of Examples 1-13, wherein the processing circuitry may be further configured to determine, based at least partly on a synchronization signal received from another STA, a reference timing for the P-NDL time block.

In Example 15, the subject matter of one or any combination of Examples 1-14, wherein the hardware processing circuitry may include a baseband processor to determine the data frame CW size.

In Example 16, the subject matter of one or any combination of Examples 1-15, wherein the originating STA may further comprise a transceiver to transmit the paging message and to receive the TF.

In Example 17, anon-transitory computer-readable storage medium may store instructions for execution by one or more processors to perform operations for contention based communication by an originating station (STA). The operations may configure the one or more processors to monitor for one or more paging messages from a group of STAs during a paging Neighborhood Area Network Data Link (P-NDL) time block. The operations may further configure the one or more processors to generate, for transmission to a destination STA in the group, a paging message in accordance with a paging contention window (CW) size. The paging CW size may be determined based at least partly on a number of paging messages detected as part of the monitoring for the paging messages. The operations may further configure the one or more processors to monitor for one or more trigger frames (TFs) from the group of STAs during the P-NDL time block. The operations may further configure the one or more processors to generate, for transmission to the destination STA, a data frame in accordance with a data frame CW size. The data frame CW size may be determined based at least partly on a number of TFs detected as part of the monitoring for the TFs.

In Example 18, the subject matter of Example 17, wherein the operations may further configure the one or more processors to detect a paging window idle period of a paging window of the P-NDL time block. The operations may further configure the one or more processors to select a paging back-off count randomly according to the paging CW size. The operations may further configure the one or more processors to detect a transmission window idle period of a transmission window of the P-NDL time block. The operations may further configure the one or more processors to select a data frame back-off count randomly according to the data frame CW size. The transmission of the paging message may be delayed by at least the paging back-off count with respect to an ending time of the paging window idle period. The transmission of the data frame may be delayed by at least the data frame back-off count with respect to an ending time of the transmission window idle period.

In Example 19, the subject matter of one or any combination of Examples 17-18, wherein the paging message and the data frame may be generated for transmission to the destination STA over a direct wireless link between the originating STA and the destination STA in accordance with a Neighborhood Area Network (NAN) protocol. The operations may further configure the one or more processors to determine a reference timing for the P-NDL time block based at least partly on a synchronization signal received from another STA.

In Example 20, a method of contention based data transmission at an originating station (STA) may comprise generating a paging message for transmission to a destination STA during a paging window of a paging Neighborhood Area Network Data Link (P-NDL) time block. The method may further comprise decoding a trigger frame (TF) received from the destination STA during a transmission window of the P-NDL time block, wherein the TF indicates a request to receive a data frame from the originating STA. The method may further comprise monitoring for other TFs exchanged between other STAs during the transmission window. The method may further comprise determining, based at least partly on the monitoring, a data frame contention window (CW) size for a contention based transmission of the data frame by the originating STA.

In Example 21, the subject matter of Example 20, wherein the method may further comprise detecting an idle period of the transmission window. The method may further comprise selecting a data frame back-off count randomly according to the data frame CW size. The method may further comprise generating the data frame for transmission to the destination STA. The transmission of the data frame may be delayed by at least the data frame back-off count with respect to an ending time of the idle period of the transmission window.

In Example 22, the subject matter of one or any combination of Examples 20-21, wherein the method may further comprising determining a reference timing for the P-NDL time block based at least partly on a synchronization signal received from another STA. The paging message and the data frame may be generated for transmission to the destination STA over a direct wireless link between the originating STA and the destination STA in accordance with a Neighborhood Area Network (NAN) protocol.

In Example 23, an apparatus for a STA may comprise memory and processing circuitry. The STA may be configurable to operate as a destination station (STA). The processing circuitry may be configured to decode a paging message received from an originating STA during a paging window of a paging Neighborhood Area Network Data Link (P-NDL) time block. The processing circuitry may be further configured to monitor for other paging messages exchanged between other STAs during the paging window. The processing circuitry may be further configured to determine a trigger frame (TF) contention window (CW) size based at least partly on the monitoring for the other paging messages exchanged between the other STAs during the paging window. The processing circuitry may be further configured to generate, for transmission to the originating STA during a transmission window of the P-NDL, time block, a TF that indicates a request to receive a data frame from the originating STA. The transmission may be in accordance with a TF back-off count selected randomly according to the determined TF CW size.

In Example 24, the subject matter of Example 23, wherein the processing circuitry may be further configured to detect a TF idle period of the transmission window. The transmission of the TF may be delayed by at least the TF back-off count with respect to an ending time of the TF idle period of the transmission window.

In Example 25, the subject matter of one or any combination of Examples 23-24, wherein the TF may be generated for transmission to the originating STA over a direct wireless link between the destination STA and the originating STA in accordance with a Neighborhood Area Network (NAN) protocol.

In Example 26, the subject matter of one or any combination of Examples 23-25, wherein the processing circuitry may be further configured to decode one or more control blocks of the other paging messages exchanged between the other STAs during the paging window to determine a number of data transmission notifications by the other STAs. The determination of the TF CW size may be further based at least partly on the number of data transmission notifications.

In Example 27, the subject matter of one or any combination of Examples 23-26, wherein the processing circuitry may be further configured to determine, based at least partly on the decoded control blocks, one or more traffic types for the data transmission notifications. The determination of the TF CW size may be further based at least partly on the determined traffic types of the data transmission notifications.

In Example 28, the subject matter of one or any combination of Examples 23-27, wherein the determined traffic types for the data transmission notifications may be in a group of Enhanced Distributed Channel Access Function (EDCAF) traffic types that includes background, best effort, video and voice.

In Example 29, the subject matter of one or any combination of Examples 23-28, wherein the originating STA and the destination STA may be included in a NAN data cluster (NDC) of two or more STAs. The P-NDL time block may be allocated for paging based communication between the STAs in the NDC. The determination of the TF CW size may be further based at least partly on a number of STAs included in the NDC.

In Example 30, the subject matter of one or any combination of Examples 23-29, wherein the processing circuitry may be further configured to determine, based at least partly on a synchronization signal received from another STA, a reference timing for the P-NDL time block.

In Example 31, the subject matter of one or any combination of Examples 23-30, wherein the processing circuitry may include a baseband processor to determine the TF CW size.

In Example 32, the subject matter of one or any combination of Examples 23-31, wherein the destination STA may further include a transceiver to receive the paging message and to transmit the TF.

In Example 33, an apparatus for an originating station (STA) may comprise means for generating a paging message for transmission to a destination STA during a paging window of a paging Neighborhood Area Network Data Link (P-NDL) time block. The apparatus may further comprise means for decoding a trigger frame (TF) received from the destination STA during a transmission window of the P-NDL time block, wherein the TF indicates a request to receive a data frame from the originating STA. The apparatus may further comprise means for monitoring for other TFs exchanged between other STAs during the transmission window. The apparatus may further comprise means for determining, based at least partly on the monitoring, a data frame contention window (CW) size for a contention based transmission of the data frame by the originating STA.

In Example 34, the subject matter of Example 33, wherein the apparatus may further comprise means for detecting an idle period of the transmission window. The apparatus may further comprise means for selecting a data frame back-off count randomly according to the data frame CW size. The apparatus may further comprise means for generating the data frame for transmission to the destination STA. The transmission of the data frame may be delayed by at least the data frame back-off count with respect to an ending time of the idle period of the transmission window.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), configurable to operate as an originating STA, the apparatus comprising memory and processing circuitry configured to:
generate a paging message for transmission to a destination STA during a paging window of a paging Neighborhood Area Network Data Link (P-NDL) time block;
decode a trigger frame (TF) that indicates a request to receive a data frame from the originating STA, the TF received from the destination STA during a transmission window of the P-NDL time block;
monitor for other TFs exchanged between other STAs during the transmission window; and
determine, based at least partly on the other TFs, a data frame contention window (CW) size for a contention based transmission of the data frame by the originating STA.

2. The apparatus according to claim 1, the processing circuitry further configured to:
detect an idle period of the transmission window;
select a data frame back-off count randomly according to the data frame CW size, and
generate the data frame for transmission to the destination STA delayed by at least the data frame back-off count with respect to an ending time of the idle period of the transmission window.

3. The apparatus according to claim 2, wherein the paging message and the data frame are generated for transmission to the destination STA over a direct wireless link between the originating STA and the destination STA in accordance with a Neighborhood Area Network (NAN) protocol.

4. The apparatus according to claim 2, the processing circuitry further configured to:
detect one or more TFs exchanged between the other STAs; and
decode one or more control blocks of the TFs exchanged between the other STAs to determine a number of data transmission requests by the other STAs,
wherein the data frame CW size is based at least partly on the number of data transmission requests.

5. The apparatus according to claim 4, wherein:
the processing circuitry is further configured to determine, based at least partly on the decoded control blocks, one or more traffic types for the data transmission requests, and
the data frame CW size is further based at least partly on the determined traffic types of the data transmission requests.

6. The apparatus according to claim 5, wherein the determined traffic types for the data transmission requests are in a group of Enhanced Distributed Channel Access Function (EDCAF) traffic types that includes background, best effort, video and voice.

7. The apparatus according to claim 2, wherein:
the data frame CW size is a first data frame CW size, the data frame is a first data frame, and the data frame back-off count is a first data frame back-off count,
the processing circuitry is further configured to:
determine a successful reception indicator for the first data frame based at least partly on an attempted reception of an acknowledgement message from the destination STA;
determine, a second data frame CW size based on the first data frame CW size and the successful reception indicator; and
determine that the first data frame is to be retransmitted to the destination STA in accordance with a second data frame back-off count selected randomly according to the second data frame CW size or generate a second data frame for transmission to the destination STA in accordance with the second data frame back-off count.

8. The apparatus according to claim 1, the processing circuitry further configured to:
monitor for other paging messages exchanged between other STAs during the paging window to determine a number of potential contending data transmissions for the transmission window; and
wherein the data frame CW size is based at least partly on the determined number of potential contending data transmissions.

9. The apparatus according to claim 1, the processing circuitry further configured to:
detect an idle period of the paging window;
select a paging back-off count randomly according to a paging CW size, and
wherein the transmission of the paging message is delayed by at least the paging back-off count with respect to an ending time of the idle period of the paging window.

10. The apparatus according to claim 9, wherein:
the paging message indicates that the originating STA intends to transmit the data frame to the destination STA,
the processing circuitry is further configured to determine the paging CW size based at least partly on a traffic type of the data frame.

11. The apparatus according to claim 10, wherein the traffic type of the data frame is one of a group of Enhanced Distributed Channel Access Function (EDCAF) traffic types that includes background, best effort, video and voice.

12. The apparatus according to claim 9, wherein:
the originating STA and the destination STA are included in a NAN data cluster (NDC) of two or more STAs,
the P-NDL time block is allocated for paging based communication between the STAs in the NDC, and
the processing circuitry is further configured to determine the paging CW size based at least partly on a number of STAs included in the NDC.

13. The apparatus according to claim 9, wherein:
a minimum length of the idle period of the paging window is based at least partly on whether the paging message is a uni-cast paging message intended for the destination STA or a multi-cast paging message intended for the destination STA and one or more additional STAs,
the minimum length of the idle period is lower for multi-cast paging messages than for uni-cast paging messages.

14. The apparatus according to claim 1, the processing circuitry further configured to determine, based at least partly on a synchronization signal received from another STA, a reference timing for the P-NDL time block.

15. The apparatus according to claim 1, wherein the hardware processing circuitry includes a baseband processor to determine the data frame CW size.

16. The apparatus according to claim 1, wherein the originating STA further comprises a transceiver to transmit the paging message and to receive the TF.

17. A non-transitory computer-readable storage medium that stores instructions for execution by one or more processors to perform operations for contention based communication by an originating station (STA), the operations to configure the one or more processors to:
monitor for one or more paging messages from a group of STAs during a paging Neighborhood Area Network Data Link (P-NDL) time block;
generate, for transmission to a destination STA in the group, a paging message in accordance with a paging contention window (CW) size, wherein the paging CW size is determined based at least partly on a number of paging messages detected as part of the monitoring for the paging messages;
monitor for one or more trigger frames (TFs) from the group of STAs during the P-NDL time block; and
generate, for transmission to the destination STA, a data frame in accordance with a data frame CW size, wherein the data frame CW size is determined based at least partly on a number of TFs detected as part of the monitoring for the TFs.

18. The non-transitory computer-readable storage medium according to claim 17, the operations to further configure the one or more processors to:
detect a paging window idle period of a paging window of the P-NDL time block;
select a paging back-off count randomly according to the paging CW size;
detect a transmission window idle period of a transmission window of the P-NDL time block;
select a data frame back-off count randomly according to the data frame CW size, and
wherein the transmission of the paging message is delayed by at least the paging back-off count with respect to an ending time of the paging window idle period,
wherein the transmission of the data frame is delayed by at least the data frame back-off count with respect to an ending time of the transmission window idle period.

19. The non-transitory computer-readable storage medium according to claim 17, wherein:
the paging message and the data frame are generated for transmission to the destination STA over a direct wireless link between the originating STA and the destination STA in accordance with a Neighborhood Area Network (NAN) protocol, and
the operations are to further configure the one or more processors to determine a reference timing for the P-NDL time block based at least partly on a synchronization signal received from another STA.

20. A method of contention based data transmission at an originating station (STA), the method comprising:
generating a paging message for transmission to a destination STA during a paging window of a paging Neighborhood Area Network Data Link (P-NDL) time block;
decoding a trigger frame (TF) received from the destination STA during, a transmission window of the P-NDL time block, wherein the TF indicates a request to receive a data frame from the originating STA;
monitoring for other TFs exchanged between other STAs during the transmission window; and
determining, based at least partly on the monitoring, a data frame contention window (CW) size for a contention based transmission of the data frame by the originating STA.

21. The method according to claim 20, further comprising:
detecting an idle period of the transmission window;
selecting a data frame back-off count randomly according to the data frame CW size, and
generating the data frame for transmission to the destination STA,
wherein the transmission of the data frame is delayed by at least the data frame back-off count with respect to an ending time of the idle period of the transmission window.

22. The method according to claim 21, the method further comprising:
determining a reference timing for the P-NDL time block based at least partly on a synchronization signal received from another STA,
wherein the paging message and the data frame are generated for transmission to the destination STA over a direct wireless link between the originating STA and the destination STA in accordance with a Neighborhood Area Network (NAN) protocol.

23. An apparatus for a STA, configurable to operate as a destination station (STA), the apparatus comprising memory and processing circuitry configured to:
decode a paging message received from an originating STA during a paging window of a paging Neighborhood Area Network Data Link (P-NDL) time block;
monitor for other paging messages exchanged between other STAs during the paging window;
determine a trigger frame (TF) contention window (CW) size based at least partly on the monitoring for the other paging messages exchanged between the other STAs during the paging window; and
generate, for transmission to the originating STA during a transmission window of the P-NDL time block, a TF that indicates a request to receive a data frame from the originating STA,
wherein the transmission is in accordance with a TF back-off count selected randomly according to the determined TF CW size.

24. The apparatus according to claim 23, the processing circuitry further configured to:
detect a TF idle period of the transmission window,
wherein the transmission of the TF is delayed by at least the TF back-off count with respect to an ending time of the TF idle period of the transmission window.

25. The apparatus according to claim 23, wherein the TF is generated for transmission to the originating STA over a direct wireless link between the destination STA and the originating STA in accordance with a Neighborhood Area Network (NAN) protocol.

26. The apparatus according to claim 23, the processing circuitry further configured to:
decode one or more control blocks of the other paging messages exchanged between the other STAs during the paging window to determine a number of data transmission notifications by the other STAs,
wherein the determination of the TF CW size is further based at least partly on the number of data transmission notifications.

27. The apparatus according to claim 26, wherein:
the processing circuitry is further configured to determine, based at least partly on the decoded control blocks, one or more traffic types for the data transmission notifications, and
the determination of the TF CW size is further based at least partly on the determined traffic types of the data transmission notifications.

28. The apparatus according to claim 27, wherein the determined traffic types for the data transmission notifications are in a group of Enhanced Distributed Channel Access Function (EDCAF) traffic types that includes background, best effort, video and voice.

29. The apparatus according to claim 23, wherein:
the originating STA and the destination STA are included in a NAN data cluster (NDC) of two or more STAs,
the P-NDL time block is allocated for paging based communication between the STAs in the NDC, and
the determination of the TF CW size is further based at least partly on a number of STAs included in the NDC.

30. The apparatus according to claim 23, the processing circuitry further configured to determine, based at least partly on a synchronization signal received from another STA, a reference timing for the P-NDL time block.

31. The apparatus according to claim 23, wherein the processing circuitry includes a baseband processor to determine the TF CW size.

32. The apparatus according to claim 23, wherein the destination STA further includes a transceiver to receive the paging message and to transmit the TF.
